(19) United States
(12) Patent Application Publication
(10) Pub. No.: US 2012/0244402 A1
(43) Pub. Date: Sep. 27, 2012

(54) SECONDARY BATTERY AND METHOD OF MANUFACTURING SECONDARY BATTERY

(76) Inventor: Tatuya SAEKI, Yokohama-shi (JP)

(21) Appl. No.: 13/424,568

(22) Filed: Mar. 20, 2012

(30) Foreign Application Priority Data
Mar. 24, 2011 (JP) 2011-066663

(51) Int. Cl. H01M 2/04; H01M 4/00; H01M 6/00

(52) U.S. Cl. 429/94; 29/623.5; 429/185

(57) ABSTRACT

A secondary battery includes a power generating electrode body, which is formed by stacking power generating elements having a separator, and a frame storing the stacked power generating electrode body wherein the power generating electrode body is stored in the frame in such a state that an electrolyte penetrates the separator at a predetermined speed and the separator is impregnated with the electrolyte supplied to the power generating electrode body in such a state that the inside of the frame is depressurized by a decompression device, and the frame sealed by a lid body while being depressurized is pressed from the stacking direction of the power generating elements by a pressing device, whereby the frame is formed into a predetermined shape.

### CROSS-REFERENCE TO RELATED APPLICATIONS

This application is based upon and claims the benefit of priority from prior Japanese Patent Application No. 2011-066663, filed Mar. 24, 2011, the entire contents of which are incorporated herein by reference.

### FIELD

An embodiment of the present invention relates to a secondary battery and a method of manufacturing a secondary battery.

### BACKGROUND

There is known a secondary battery in which a power generating electrode body having a separator provided between a positive plate and a negative plate is wrapped in the form of a coil, and the wrapped power generating electrode body is stored in a container. The separator is impregnated with an electrolyte, the power generating electrode body is sealed in the container by a lid body attached to an upper surface of the container, and charging and discharging are performed through positive and negative electrode terminals provided at the lid body.

In the secondary battery, since the charging and discharging capacities are determined basically corresponding to the area of the power generating electrode body, when a small secondary battery having large charging and discharging capacity is formed, it is desirable to store a large number of the power generating electrode bodies in a container.

When a large number of the power generating electrode bodies are stored in a narrow container, the power generating electrode bodies are closely wrapped, and a gap between the positive plate and the negative plate is reduced, so that the electrolyte is less likely to penetrate the separator.

### BRIEF DESCRIPTION OF THE DRAWINGS

FIG. 1 is a perspective view showing an embodiment of a secondary battery;

FIG. 2 is a perspective view showing a state of the secondary battery before pressing;

FIG. 3 is an exploded perspective view showing an embodiment of a method of manufacturing a secondary battery;

FIG. 4 is a perspective view showing an embodiment of the manufacturing method;

FIG. 5 is a perspective view showing an embodiment of the manufacturing method;

FIG. 6 is a perspective view showing an embodiment of a power generating electrode body of the secondary battery;

FIG. 7 is a cross-sectional view showing an embodiment of the secondary battery; and

FIG. 8 is a cross-sectional view showing an embodiment of the secondary battery.

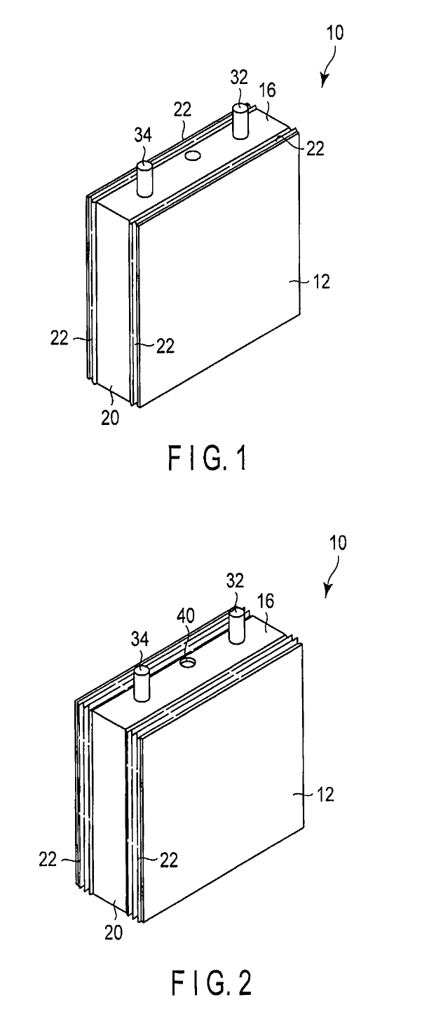

### DETAILED DESCRIPTION

A method of manufacturing a secondary battery according to one aspect includes stacking a power generating element having a positive plate, a negative plate, and a separator provided between the positive plate and the negative plate in such a state that the separator is impregnated with an electrolyte at a predetermined speed and storing the power generating element in an outer frame body, supplying the electrolyte to the separator in the outer frame body in such a state that the inside of the outer frame body is depressurized and then sealing the outer frame body; and impregnating the separator with the electrolyte, then pressing the outer frame body in a stacking direction of the power generating element, and forming the outer frame body and the stacked power generating element into a predetermined shape.

A secondary battery according to one aspect includes a power generating electrode body, which is formed by stacking power generating elements having a positive plate, a negative plate, and a separator provided between the positive plate and the negative plate, and an outer frame body storing the stacked power generating electrode body wherein the power generating electrode body is stored in the outer frame body in such a state that an electrolyte penetrates the separator at a predetermined speed. The separator is impregnated with the electrolyte supplied to the power generating electrode body in such a state that the inside of the outer frame body is depressurized by a decompression device, and the outer frame body sealed by a lid body while being depressurized is pressed from the stacking direction of the power generating elements by a pressing device, whereby the outer frame body is formed into a predetermined shape.

An embodiment of a secondary battery and a method of manufacturing a secondary battery will be described.

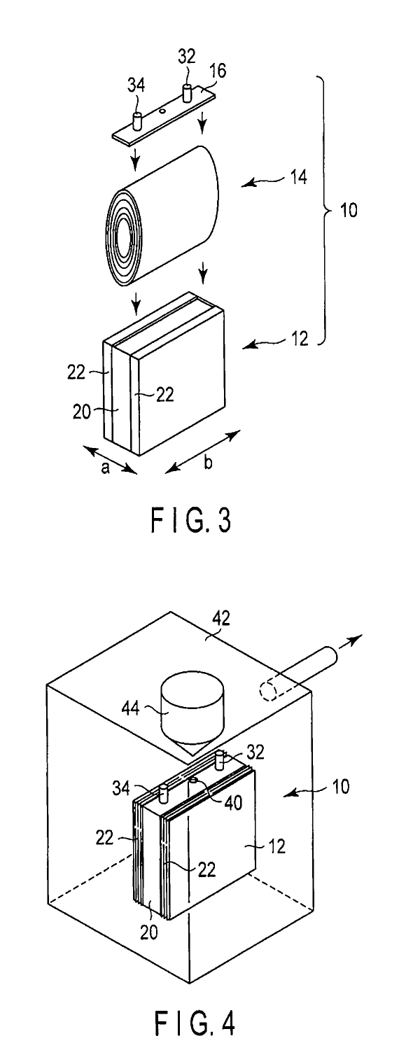

A secondary battery 10 is shown in FIG. 1. The secondary battery 10 has a flat rectangular solid shape and includes positive and negative electrode terminals 32 and 34 on the upper surface. FIG. 3 shows an exploded view of the secondary battery 10. As shown in FIG. 3, the secondary battery 10 is constituted of an outer frame body 12, a power generating electrode body 14, and a lid body 16.

The outer frame body 12 is formed of a metal material and has a shape that can store the power generating electrode body 14. In the outer frame body 12, the thickness in the depth direction (shown by the arrow a) is smaller than the length in the width direction (shown by the arrow b), and variable portions 22 having a bellows structure are provided on a sidewall 20 provided along the depth. The variable portion 22 is formed on all the wall surfaces of the outer frame body 12 including upper, lower, left, and right surfaces. The sidewall 20 can be shrunk in the depth direction by folding operation of the variable portions 22.

In the variable portion 22, if the length in the depth direction can be changed, a structure other than the bellows structure may be used. Further, the variable portions 22 may be provided not on the both sides of the sidewall 20, but the variable portion 22 may be provided on any one of the both sides of the sidewall 20. Even if the outer frame body 12 can deform not in the depth direction but in the width direction (shown by the arrow b) or the height direction, the outer frame body 12 includes at least the variable portion 22 provided along the stacking direction of the power generating electrode body 14 and may be able to be shrunk in such a direction.

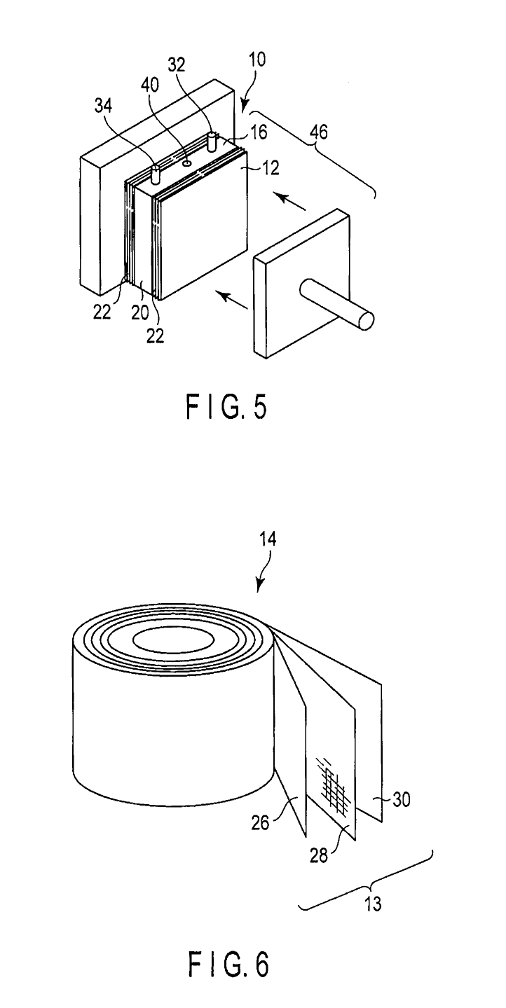

The power generating electrode body 14 has a cylindrical shape with an elliptical cross section and, as shown in FIG. 6, is constituted of a power generating element 13 constituted of a positive plate 26, a negative plate 28, and a separator 30. The separator 30 is impregnated with an electrolyte, and the power generating element 13 can charge and discharge while the separator 30 impregnated with the electrolyte is held between the positive plate 26 and the negative plate 28. The power generating electrode body 14 is formed so that the uninterrupted power generating element 13 is wrapped elliptically. The separator 30 is formed of glass fibers and a resin material, for example, and formed of a material impregnated with an electrolyte.

The lid body 16 includes the positive and negative electrode terminals 32 and 34 and attached to the upper surface of the outer frame body 12. The positive electrode terminal 32 is connected to the positive plate 26 of the power generating electrode body 14, and the negative electrode terminal 34 is connected to the negative plate 28. The power generating electrode body 14 is stored in the outer frame body 12 in a state of being wrapped and is sealed in the outer frame body 12 as a container attached with the lid body 16. When electric power is applied to the secondary battery 10 from outside, the secondary battery 10 produces electrochemical reaction in the power generating element 13 to store electricity, and if a load is connected to the secondary battery 10, the secondary battery 10 discharges electricity as a result of reverse reaction, whereby charging and discharging are repeated.

Next, a method of manufacturing the secondary battery 10 will be described.

The separator 30 is arranged on the surface of the positive plate 26, and the negative plate 28 is arranged on the surface of the separator 30, whereby the power generating element 13 is formed. The obtained power generating elements 13 are sequentially wrapped around a wrapping portion. The wrapping portion has an elliptical cross section and is rotated and driven by a drive mechanism to wrap the power generating element 13 with a predetermined tensile strength, and, thus, to form the power generating electrode body 14.

The predetermined tensile strength for wrapping the power generating element 13 constitutes the following state. Namely, the power generating element 13 is wound around the wrapping portion a predetermined number of times with such a tensile strength to form the power generating electrode body 14, and then the power generating electrode body 14 is removed from the wrapping portion. When an electrolyte is supplied under a predetermined decompression state from the upper and lower end surfaces of the power generating electrode body 14, that is, the end surfaces on which the stacking state of the positive plate 26, the negative plate 28, and the separator 30 is exposed, the electrolyte penetrates the separator 30 at a predetermined speed, and a gap is formed between the positive plate 26 and the negative plate 28 so that the entire separator 30 is impregnated with the electrolyte within a predetermined time.

The power generating electrode body 14 wrapped with such a tensile strength is stored in the outer frame body 12 as shown in FIG. 1. The outer frame body 12 has an enlarged shape before being pressed. After the power generating electrode body 14 is stored in the outer frame body 12, the lid body 16 is attached to the outer frame body 12. The lid body 16 is adhered firmly to the outer frame body 12, and the inside of the outer frame body 12 is sealed remaining an inlet 40 provided at the lid body 16.

After the lid body 16 is attached to the outer frame body 12, the outer frame body 12 storing the power generating electrode body 14 is stored in a decompression device 42 as shown in FIG. 4, and the decompression device 42 is operated. The decompression device 42 is connected to a vacuum pump and keeps the inside of the outer frame body 12 at a predetermined decompression state. The electrolyte is injected from an injection device 44 into the outer frame body 12 through the inlet 40 of the lid body 16 in such a state that a decompression atmosphere is maintained by the decompression device 42. After the injection of the electrolyte into the outer frame body 12, the inlet 40 is sealed. The inlet 40 is sealed with such a strength that the inlet 40 is not easily opened because of a difference in pressure inside and outside in the outer frame body 12.

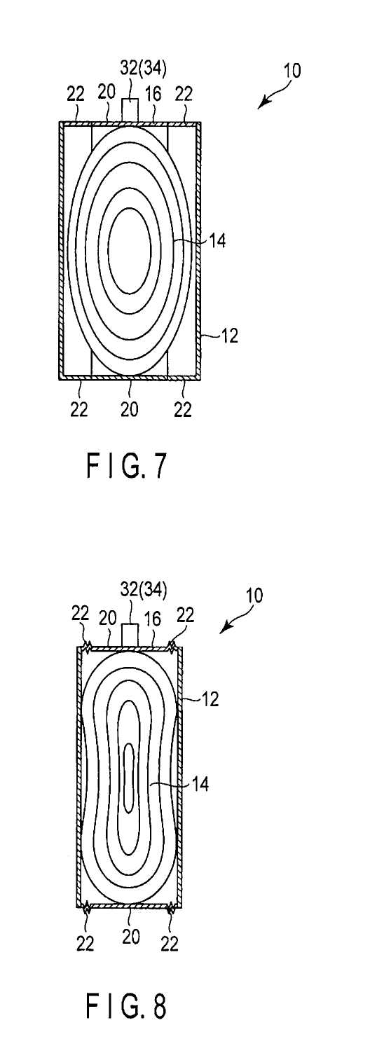

The outer frame body 12 in which the power generating electrode body 14 is stored therein and the inlet 40 is sealed is removed from the decompression device 42, and after a lapse of a predetermined time, for example, the time estimated that the electrolyte penetrates the entire separator 30, the outer frame body 12 is pressed by a pressing machine 46. The pressing machine 46 presses the outer frame body 12 along the depth direction and forms the depth width of the outer frame body 12 into a predetermined length. In the formation of the outer frame body 12, the variable portions 22 with the bellows structure formed on the sidewall 20 of the outer frame body 12 are deformed by being pressed by the pressing machine 46. Simultaneously with the formation of the outer frame body 12, the power generating electrode body 14 stored in the outer frame body 12 is pressed and deformed into a flatter elliptical shape shown in FIG. 8 from the state of FIG. 7.

Each state of the secondary battery 10 shown in FIGS. 1 and 8 is desired shape and state of the secondary battery 10 and the complete shape of the secondary battery 10. Therefore, according to the method of manufacturing a secondary battery, since the wrapped power generating electrode body 14 is stored in the outer frame body 12 in such a state that the electrolyte penetrates the separator 30 at a predetermined speed, the separator 30 can be impregnated with the supplied electrolyte within a predetermined time.

According to the above constitution, the impregnation of the separator 30 with the electrolyte can be completed within a desired time, and the secondary battery can be manufactured within a short time and at low cost. Since the secondary battery 10 is pressed and molded into a predetermined shape, the secondary battery 10 is miniaturized to have a desired shape.

Since the outer frame body 12 is pressed by the pressing machine 46 while keeping a state that the inside of the outer frame body 12 is depressurized, the pressure inside the outer frame body 12 is not excessively increased by pressing and deformation by the pressing machine 46. The amount of electrolyte injected into the outer frame body 12 is set so that the outer frame body 12 is pressed into a width of a predetermined shape, and a space with a predetermined capacity may be provided between the outer frame body 12 and the lid body 16. Although the outer frame body 12 is formed of metal, the outer frame body 12 may be formed of another material, and even if the outer frame body 12 is formed of another material, similar effects can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of manufacturing a secondary battery, comprising:
stacking a power generating element having a positive plate, a negative plate, and a separator provided between the positive plate and the negative plate in such a state that the separator is impregnated with an electrolyte at a predetermined speed and storing the power generating element in an outer frame body;
supplying the electrolyte to the separator in the outer frame body in such a state that the inside of the outer frame body is depressurized and then sealing the outer frame body; and
impregnating the separator with the electrolyte, then pressing the outer frame body in a stacking direction of the power generating element, and forming the outer frame body and the stacked power generating element into a predetermined shape.

2. The method of manufacturing a secondary battery according to claim 1, wherein
the power generating element is wrapped into an elliptical shape, and
the wrapped power generating element is pressed in a minor axis direction of the elliptical shape.

3. The method of manufacturing a secondary battery according to claim 1, wherein
the power generating element is wrapped with such a tensile force that the electrolyte penetrates the separator at a predetermined speed when the electrolyte is supplied to the separator.

4. A secondary battery comprising:
a power generating electrode body formed by stacking a power generating element having a positive plate, a negative plate, and a separator provided between the positive plate and the negative plate; and
an outer frame body storing the power generating electrode body in a state of being stacked,
wherein the power generating electrode body is stored in the outer frame body in such a state that an electrolyte penetrates the separator at a predetermined speed,
the separator is impregnated with the electrolyte supplied to the power generating electrode body in such a state that the outer frame body is depressurized by a decompression device, and
the depressurized outer frame body sealed by a lid body is pressed from a stacking direction of the power generating element by a pressing device to form the outer frame body into a predetermined shape.

5. The secondary battery according to claim 4, wherein
in the power generating electrode body, the power generating element is continuously wrapped elliptically to be stacked,
the outer frame body has, at a peripheral edge of at least one surface of outer peripheral surfaces of the outer frame body, a variable portion which can deform so that an interval between the one surface and a facing surface facing the one surface is changed between the one surface and the facing surface, and
the power generating electrode body is stored in the outer frame body so that a direction of stacking the power generating element and a deformation direction of the variable portion coincide with each other.
